(19) United States
(12) Patent Application Publication
(10) Pub. No.: US 2018/0194525 A1
(43) Pub. Date: Jul. 12, 2018

(54) CONTAINER SYSTEM

(71) Applicant: Leprino Performance Brands LLC, Denver, CO (US)

(72) Inventors: Mike Arnold, Denver, CO (US); Paul Vraciu, Denver, CO (US); Elizabeth Marie Barrett, Newburgh, IN (US); Scott Lee Fisher, Evansville, IN (US)

(73) Assignee: Leprino Performance Brands LLC, Denver, CO (US)

(21) Appl. No.: 15/405,184

(22) Filed: Jan. 12, 2017

(51) Int. Cl. B65D 51/24; B65D 43/16; B65D 43/22; G01F 19/00

(52) U.S. Cl. CPC B65D 51/246; G01F 19/002; B65D 43/22; B65D 43/16

(57) ABSTRACT

The present disclosure is directed to a container system that includes a lid, a first rail coupled to the lid, and a second rail coupled to the lid. A measuring scoop is configured to couple to the lid with the first and second rails. The measuring scoop includes a cup portion with a front rim, and a handle portion coupled to the cup portion. The front rim of the cup portion couples to the first rail and the handle portion couples to the second rail.

### FIELD OF THE INVENTION

The disclosure generally relates to a container system with a removable scoop.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Products come in a variety of forms such as powders, pellets, flakes, liquids, etc. that are packaged in different ways. For example, products may be packaged in sacks, boxes, cartons, bottles, and cans. Some of these containers may store a product for repeated use over an extended period of time. In other words, the container may store more product than will be used in a single setting. In these situations, a user may use a measuring scoop or cup to remove the desired amount of product while storing the remaining product for future use.

### SUMMARY OF THE INVENTION

The present disclosure is directed to a container system that includes a lid, a first rail coupled to the lid, and a second rail coupled to the lid. A measuring scoop is configured to couple to the lid with the first and second rails. The measuring scoop includes a cup portion with a front rim, and a handle portion coupled to the cup portion. The front rim of the cup portion couples to the first rail and the handle portion couples to the second rail.

An aspect of the disclosure includes a container system with a lid, a first rail coupled to the lid, a second rail coupled to the lid. A measuring scoop is configured to couple to the lid with the first and second rails. The measuring scoop includes a cup portion with a first side ledge, a second side ledge, and a handle portion coupled to the cup portion. The first side ledge couples to the first rail and the second side ledge couples to the second rail.

Another aspect of the disclosure includes a container system with a container and a lid coupled to the container. A first rail couples to at least one of the container and lid. A second rail couples to at least one of the container and lid. A measuring scoop is configured to couple to at least one of the container and the lid. The measuring scoop includes a cup portion with a front rim, and a handle portion coupled to the cup portion, wherein the front rim of the cup portion couples to the first rail and the handle portion couples to the second rail.

### BRIEF DESCRIPTION OF THE DRAWINGS

Various features, aspects, and advantages of the present invention will be better understood when the following detailed description is read with reference to the accompanying figures in which like characters represent like parts throughout the figures, wherein:

FIG. 1 is a perspective view of an embodiment of an open container system with a removable scoop being inserted into a lid;

FIG. 2 is a perspective view of an embodiment of a container system with a removable scoop coupled to a lid;

FIG. 3 is a perspective view of an embodiment of a closed container system with a removable scoop coupled to a lid;

FIG. 4 is a perspective view of an embodiment of a removable scoop;

FIG. 5 is a side view of an embodiment of a removable scoop;

FIG. 6 is a perspective view of an embodiment of a removable scoop with a retention feature;

FIG. 7 is a side view of an embodiment of a removable scoop with a retention feature;

FIG. 8 is a cross-sectional view of an embodiment of a rail with a retention feature;

FIG. 9 is a cross-sectional view of an embodiment of a rail with a retention feature;

FIG. 10 is a cross-sectional view of an embodiment of a rail with a retention feature;

FIG. 11 is a perspective view of an embodiment of an open container system with a removable scoop being inserted into a lid; and

FIG. 12 is a perspective view of an embodiment of a container system with a removable scoop coupled to a lid.

### DETAILED DESCRIPTION

One or more specific embodiments of the present invention will be described below. These embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The embodiments discussed below include a container system with a removable scoop for removing measured amounts of product (e.g., powders, pellets, flakes, liquid, etc.) from a container. The removable scoop couples to the container system, which enables a user to easily retrieve as well as store the removable scoop for future use. The removable scoop couples to the container system with rails. For example, the removable scoop may include a cup portion that couples to a first rail and a handle portion that couples to a second rail. In some embodiments, the removable scoop may couple to the container system with rails that engage opposing side ledges on a cup portion.

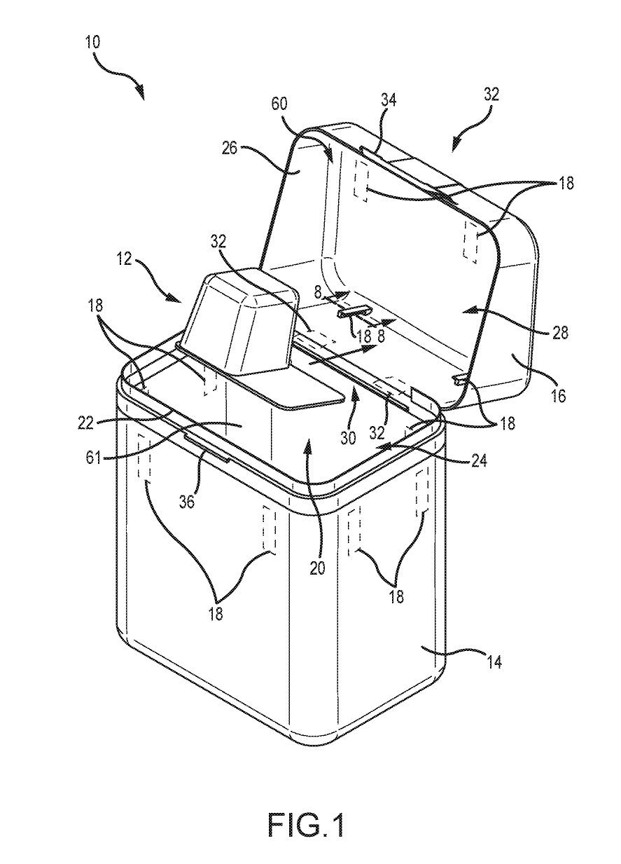

FIG. 1 is a perspective view of an embodiment of an open container system 10 with a removable scoop 12. In operation, the removable scoop 12 enables a user to scoop measured amounts of product out of a container 14. After using the removable scoop 12, the user may secure the removable scoop 12 to the container 14 and/or to the lid 16 for future use. This ensures that the removable scoop 12 is always readily accessible.

As will be discussed in detail below, the removable scoop 12 couples to the container 14 and/or the lid 16 with rails 18 that are coupled to the container 14 and/or lid 16. The rails 18 may be integral to the container 14 and/or lid 16 (e.g., one-piece) or they may be separately attached (e.g., snap fit, compression fit, welded, etc.). In some embodiments, the container system 10 may include multiple pairs of rails 18 on the container 14 and/or the lid 16, which enable a user to attach the removable scoop 12 to the container 14 or lid 16. Furthermore, by including multiple pairs of rails 18, the container system 10 may also enable attachment of more than one removable scoop 12. For example, the container system 10 may include differently sized removable scoops (e.g., 1, 2, 3, or more differently sized removable scoops).

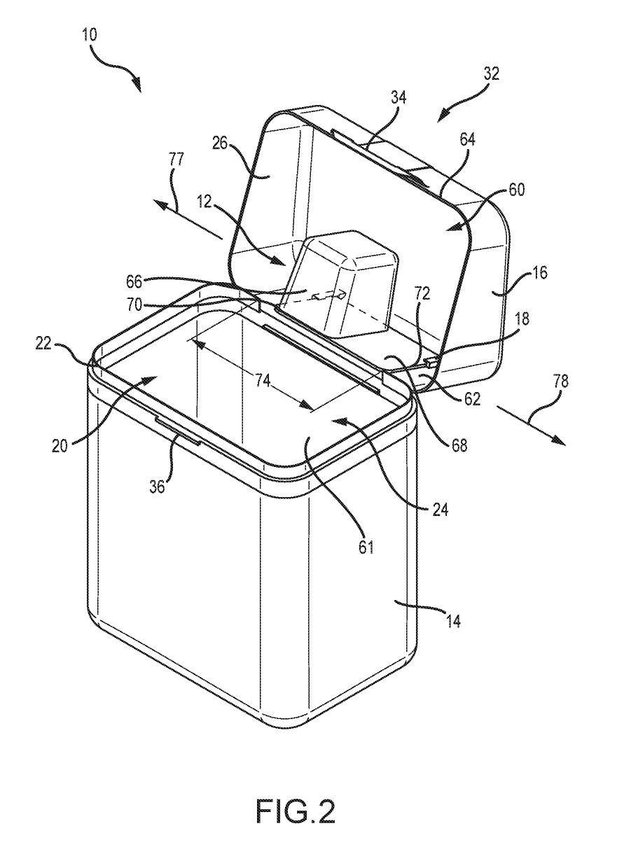

As illustrated, the container 14 and lid 16 have a generally rectangular shape. In other embodiments, the container 14 and/or lid 16 may have another shape (e.g., square, cylindrical, oval, trapezoidal, irregular, etc.). In order to contain product within a cavity 20, the container 14 and lid 16 couple together. For example, the container 14 and lid 16 may be cylindrically shaped and include respective threads that enable the lid 16 to threadingly couple to the container 14 when the lid 16 is circumferentially rotated about the container 14. In some embodiments, the container 14 and lid 16 may be snap fit together. In another embodiment, the container 14 and lid 16 may be compression fit together. For example, the container 14 may include a rim 22 that extends completely or partially about the opening 24 in the container 14. When the container 14 and lid 16 couple together (e.g., compression fit, snap fit, threadingly engaged), the rim 22 may engage the interior surface 26 of the lid 16 around the opening 28. In some embodiments, the rim 22 may not extend around the entire opening 24. For example, the rim 22 may include a gap 30 that facilitates insertion and removal of the removable scoop 12 from the lid 16. In some embodiments, the lid 16 may couple to the container 14 with a latch 32. As illustrated, in FIG. 2, the latch 32 may include a flap 34 that projects from the lid 16 and couples to a ledge 36 (e.g., rim, protrusion, etc.) on the container 14 in a closed position. Once engaged, the latch 32 closes the container system 10, which blocks product from exiting the container system 10.

In some embodiments, the container 14 and lid 16 may include a hinge 38 that cooperates with the latch 32 to open and close the container system 10. For example, the container 14 and the lid 16 may be coupled together with one or more hinges 38. The hinge(s) 32 may be a butt hinge, butterfly hinge, flush hinge, barrel hinge, concealed hinge, friction hinge, continuous hinge, or a combination thereof, etc. In some embodiments, the hinge 38 may be a flexible piece of material (e.g., plastic) that couples the container 14 to the lid 16.

FIG. 2 is a perspective view of an embodiment of a container system 10 with a removable scoop 12 coupled to a lid 16. As illustrated, the removable scoop 12 slides into a lid cavity 60 and couples to rails 18. The rails 18 couple to the interior surface 26 of the lid 16 or the interior surface 61 of the container 14 to hold/retain the removable scoop 12 within the container 14 or lid 16. In some embodiments, the rails 18 may be positioned on a hinge wall 62 (e.g., sidewall) in the lid 16 opposite a latch wall 64 (e.g., sidewall). By coupling the removable scoop 12 to the hinge wall 62, the container system 10 may facilitate access to the removable scoop 12.

However, as explained above, the removable scoop 12 may couple to the lid 16 and container 14 at different locations (e.g., bottom walls, sidewalls).

The removable scoop 12 includes a cup/scoop portion 66 and a handle portion 68 that couple to respective rails 18. Specifically, the cup portion 66 includes a front rim 70 that enables a rail 18 to hold/retain the cup portion 66 between the rail 18 and the interior surface 26 of the container 14. The handle portion 68 is likewise held/retained between a rail 18 and the interior surface 26 of the lid 16. In some embodiments, a rail 18 couples to a distal end 72 of the handle portion 68. As illustrated, the rails 18 may be spaced from each other a distance 76 to accommodate coupling to the front rim 70 of the cup/scoop portion 66 and the distal end 72 of the handle portion 68. In this way, the rails 18 may block axial shifting of the removable scoop in axial directions 77, 78, and therefore unintentional detachment from the container 14 or lid 16.

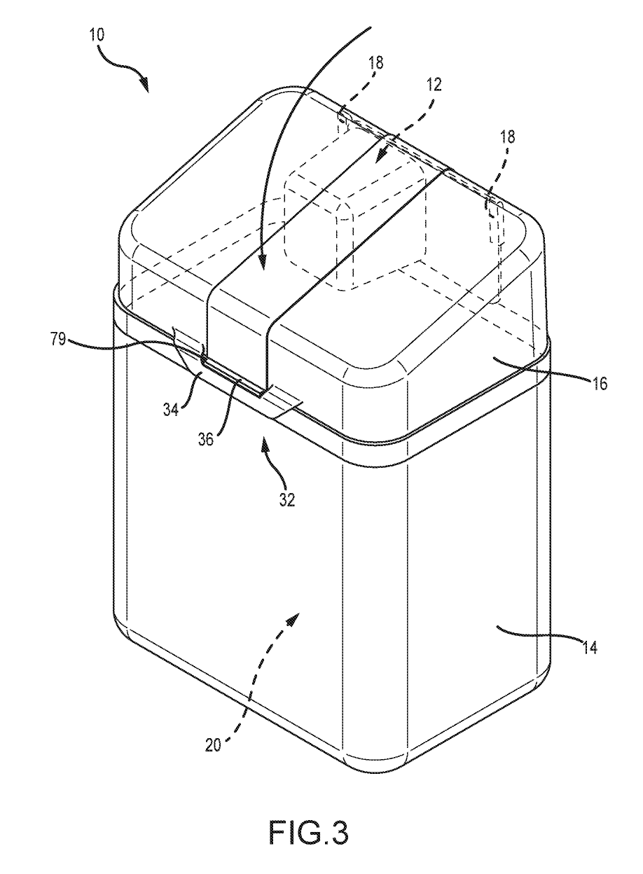

FIG. 3 is a perspective view of an embodiment of a closed container system 10 with a removable scoop 12. As illustrated, the rails 18 couple to and retain the removable scoop 12 within the lid 16. In other words, the rails 18 block the removable scoop 12 from falling into the cavity 20 of the container 14. As explained above, the container system 10 includes the latch 32 to couple the lid 16 to the container 14. The latch 32 includes the flap 34 on the lid 16, which couples to the ledge 36 on the container 14. In other embodiments, the latch 32 may be reversed with the flap 34 on the container 14 and the ledge 36 on the lid 16. In some embodiments, the flap 34 may include an aperture 79 that receives the ledge 36 to couple the lid 16 to the container 14.

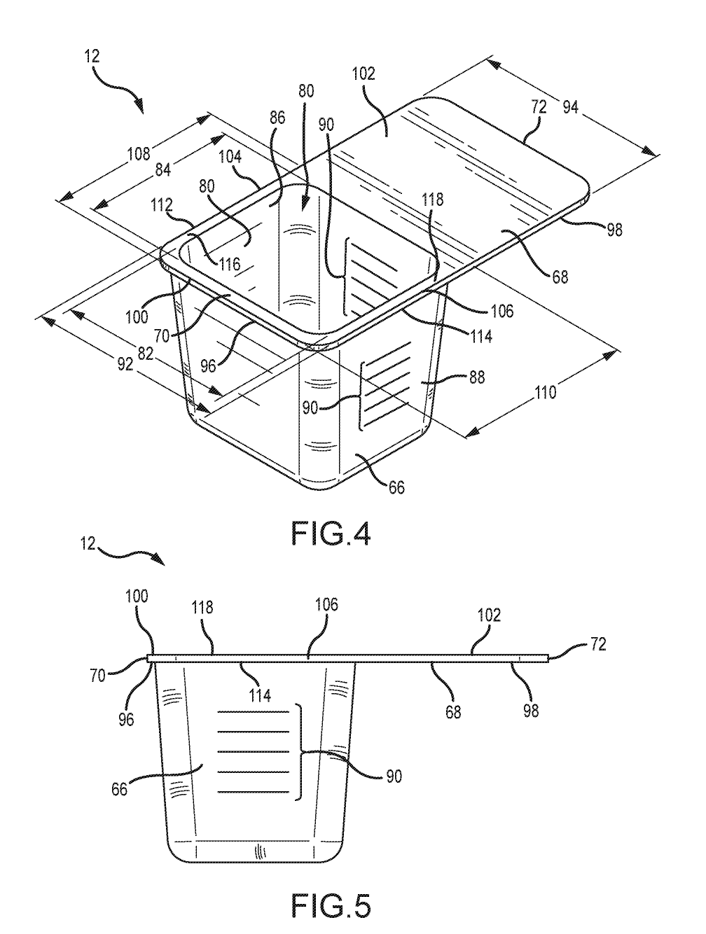

FIGS. 4 and 5 illustrate perspective and side views of an embodiment of a removable scoop 12. The removable scoop 12 includes a cup portion 66 and a handle portion 68. The cup portion 66 forms a cavity 80 that enables a user to scoop measured amounts of product out of the container 14. In FIGS. 4 and 5, the cup portion 66 and cavity 80 define a square/rectangular shape with a width 82 and a length 84. However, other embodiments of the removable scoop 12 may have a differently shaped cup portion 66 and/or cavity 80 (e.g., circular, oval, irregular, etc.). Similarly, the handle portion 68, though illustrated in a square/rectangular shape, may have a different shape such as semi-circular shape, triangular shape, teardrop shape, irregularly shape, etc.

To facilitate measurement of product, an interior surface 86 and/or an exterior surface 88 of the cup portion 66 may include measurement markings 90. The markings 90 may be numbers, words, letters (e.g., ml, mm, oz., etc.), symbols (e.g., lines), or a combination thereof. In some embodiments, the removable scoop 12 may include a clear, transparent, semi-transparent material (e.g., plastic) that enables a user to simultaneously see the markings 90 and the amount of product in the cavity 80.

In order to couple the removable scoop 12 to the container system 10, the cup portion 66 includes the front rim or ledge 70 and the handle portion 68. As explained above, the front rim 70 and handle portion 68 couple to respective rails 18 that hold the removable scoop 12 within the lid 16 or the container 14. For example, a rail 18 may extend over an entire length 92 of the front rim 70. In some embodiments, a rail 18 may extend over a portion of the front rim 70 instead of the entire length 92. Likewise, a rail 18 may extend over an entire length 94 of the distal end 72 or a portion thereof. When coupled, the rails 18 contact a bottom surface 96 of the front rim and a bottom surface 98 of the handle portion 68 to pin/hold the top surface 100 of the front rim 70 and the top surface 102 of the handle portion 68 against the container 14 and/or lid 16.

As illustrated, the length 92 of the front rim 70 and the length 94 of the distal end 72 may be greater than the width 82 of the cavity 80 to increase a contact area with the rails 18. However, in some embodiments the length 92 of the front rim 70 and/or the length 94 of the distal end 72 may be less than or equal to the width 82 of the cavity 80.

In some embodiments, the cup portion 66 may include side ledges 104, 106 that enable the removable scoop 12 to couple to the rails 18, instead of using the front rim 70 and handle portion 68. The side ledges 104, 106 have respective lengths 108 and 110. When coupled to the container system 10, the rails 18 may extend over the entire lengths 108, 110 of the side ledges 104, 106 or a portion thereof. The rails 18 contact respective bottom surfaces 112, 114 of the side ledges 104, 106 to pin/hold the top surface 116 of the side ledge 104 and the top surface 118 of the side ledge 106 against the container 14 and/or lid 16.

As illustrated, the lengths 108 and 110 of the side ledges 104, 106 may be greater than the length 84 of the cavity 80 to increase the available contact area with the rails 18. However, in some embodiments, the lengths 108 and 110 of the side ledges 104, 106 may be less than or equal to the length 84 of the cavity 80.

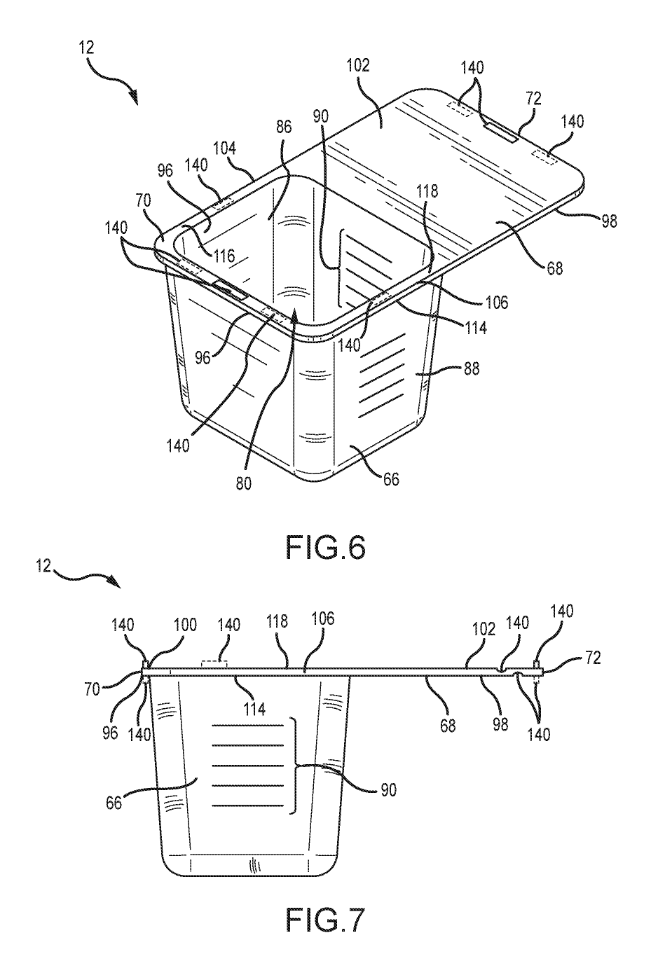

FIGS. 6 and 7 illustrate perspective and side views of an embodiment of a removable scoop 12 with one or more retention features 140. The retention features 140 may be protrusions, recesses, or a combination thereof that facilitate retention and coupling of the removable scoop 12 to the rails 18. The retention features 140 may have a variety of shapes including circular, square, rectangular, etc. As illustrated, the handle portion 68, front rim 70, and side ledges 104, 106 may include one or more retention features 140. In some embodiments, the retention features 140 enable the removable scoop 12 to snap fit with the rails 18, the container 14, and/or the lid 16.

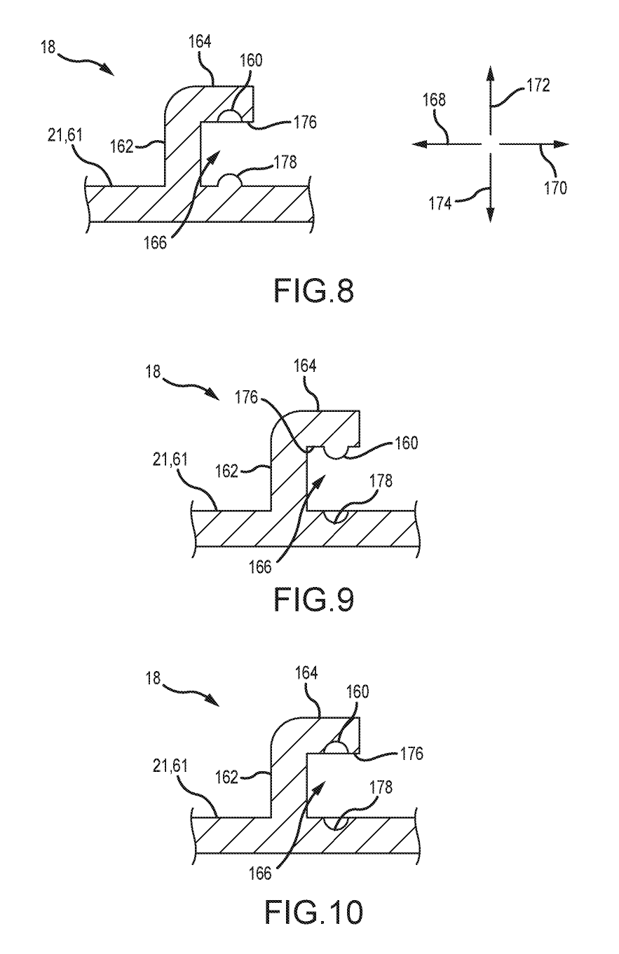

FIG. 8 is a cross-sectional view of an embodiment of a rail 18 with a retention feature 160. As illustrated, the rail 18 couples to interior surfaces 26, 61 of the respective lid 16 or container 14. The rails 18 may be integral (e.g., one-piece) to the container 14 or lid 16 or they may be separately attached (e.g., press fit, welded, snap fit, etc.). The rails 18 include a wall 162 that extends perpendicular or substantially perpendicular to the interior surfaces 26, 61. Coupled to the wall 162 is a ledge or lip 164 that extends over the front rim 70, distal end 72, or side ledges 104, 106 when the removable scoop 12 is inserted into the rails 18. As illustrated, the wall 162 and ledge 164 form a rectangular cavity 166 to accommodate a generally rectangular cross-section of the front rim 70, handle portion 68, and side ledges 104, 106. However, in some embodiments, the wall 162 and ledge 164 may form a semi-circular cavity, triangular cavity, etc. that receives a corresponding cross-sectionally shaped front rim 70, handle portion 68, or side ledges 104, 106.

In operation, the walls 162 block axial movement in axial directions 168, 170 while the ledges 164 block movement in axial direction 172, and the surfaces 26, 61 block movement in axial direction 174. In some embodiments, the removable scoop 12 and rails 18 may form a compression fit that retains the removable scoop 12 in contact with the rails 18. For example, the cavity 166 may be smaller than the cross-section of the front rim 70, the handle portion 68, or side ledges 104, 106. In some embodiments, the removable scoop 12 may include retention features 140 that snap fit and/or compression fit with corresponding retention features 160 on the rails 18. For example, a recess retention feature 160 on the rail 18 may couple to a protrusion retention feature 140 on the removable scoop 12 or vice versa. As illustrated in FIGS. 8, 9, and 10, the retention features 160 may be recesses and/or protrusions on a surface 176 of the ledge 164. Furthermore, FIGS. 8, 9, and 10 illustrate embodiments with retention features 178 on the interior surfaces 26 of the lid 16 or interior surface 61 on the container 14. Like the discussion above, the retention features 178 may be protrusions and/or recesses that correspond to retention features 140 on the removable scoop 12.

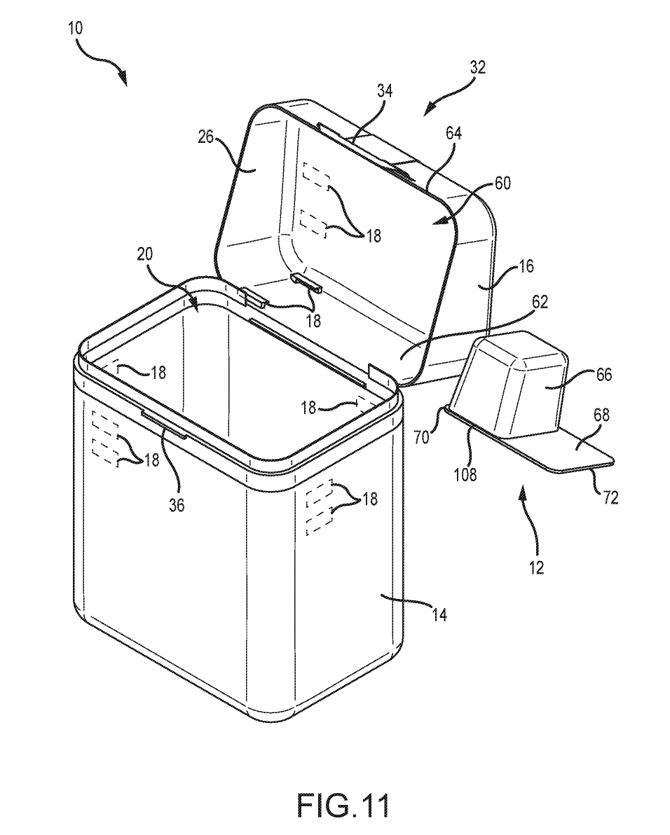

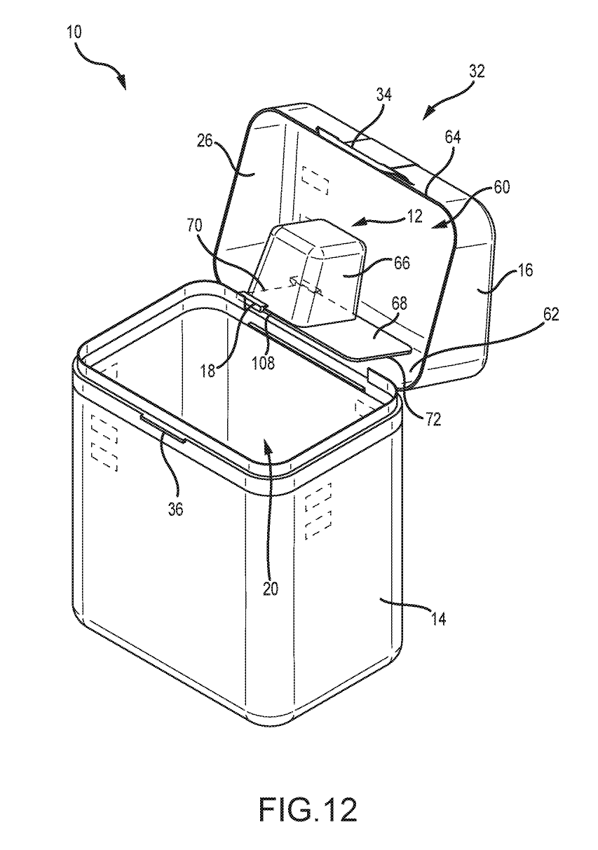

FIG. 11 is a perspective view of an embodiment of an open container system 10 with a removable scoop 12 being inserted into a lid 16. As explained above, the removable scoop 12 may couple to rails 18 with side ledges 104, 106. In some embodiments, the side ledges 104, 106 may form a compression fit with the rails 18 that blocks movement of the removable scoop 12 with respect to the container 14 or the lid 16. The side ledges 104, 106 may also include retention features 140 that couple to corresponding retention features 160 on the rails 18 or retention features 178 on the surfaces 26, 61 of the lid 16 or container 14. FIG. 12 is a perspective view of an embodiment of the container system 10 with the side ledges 104, 106 of the removable scoop 12 coupled to the rails 18.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A container system, comprising:
a lid;
a first rail coupled to the lid;
a second rail coupled to the lid; and
a measuring scoop configured to couple to the lid with the first and second rails,
the measuring scoop comprising:
a cup portion with a front rim; and
a handle portion coupled to the cup portion;
wherein the front rim of the cup portion couples to the first rail and the handle portion couples to the second rail.

2. The container system of claim 1, wherein the second rail couples to a distal end of the handle portion.

3. The container system of claim 1, comprising a container with a cavity configured to receive a product, wherein the container couples to the lid.

4. The container system of claim 1, wherein the first rail includes a first wall that couples to the lid and a first lip that extends from the first wall, wherein the first rail captures the front rim of the cup portion between a lid surface and a bottom surface of the first lip.

5. The container system of claim 1, wherein the second rail includes a second wall that couples to the lid and a second lip that extends from the second wall, wherein the second rail captures the handle portion between a lid surface and a bottom surface of the second lip.

6. The container system of claim 1, wherein the first rail comprises a first retention feature that engages a second retention feature on the front rim.

7. The container system of claim 6, wherein the first retention feature is at least one of a protrusion and a recess.

8. The container system of claim 6, wherein the second retention feature is at least one of a protrusion and a recess.

9. The container system of claim 1, wherein the second rail comprises a first retention feature that engages a second retention feature on the handle portion.

10. The container system of claim 9, wherein the first retention feature is at least one of a protrusion and a recess.

11. The container system of claim 9, wherein the second retention feature is at least one of a protrusion and a recess.

12. The container system of claim 1, wherein the first rail and the second rail couple to a side surface of the lid.

13. The container system of claim 1, wherein the first rail and the second rail couple to a bottom surface of the lid.

14. A container system, comprising:
a lid;
a first rail coupled to the lid;
a second rail coupled to the lid; and
a measuring scoop configured to couple to the lid with the first and second rails,
the measuring scoop comprising:
a cup portion with a first side ledge and a second side ledge; and
a handle portion coupled to the cup portion;
wherein the first side ledge couples to the first rail and the second side ledge couples to the second rail.

15. The container system of claim 12, comprising a container with a cavity configured to receive a product, wherein the lid couples to the container.

16. The container system of claim 14, wherein the first rail includes a first wall that couples to the lid and a first lip that extends from the first wall, wherein the first rail captures the front rim of the cup portion between a lid surface and a bottom surface of the first lip.

17. The container system of claim 14, wherein the second rail includes a second wall that couples to the lid and a second lip that extends from the second wall, wherein the second rail captures the handle portion between a lid surface and a bottom surface of the second lip.

18. The container system of claim 14, wherein the first rail comprises a first retention feature, and wherein the first retention feature is at least one of a protrusion and a recess.

19. The container system of claim 14, wherein the second rail comprises a second retention feature, and wherein the second retention feature is at least one of a protrusion and a recess.

20. A container system, comprising:
a container;
a lid coupled to the container;
a first rail coupled to at least one of the container and lid;
a second rail coupled to at least one of the container and lid; and
a measuring scoop configured to couple to at least one of the container and the lid,
the measuring scoop comprising:
a cup portion with a front rim; and
a handle portion coupled to the cup portion;
wherein the front rim of the cup portion couples to the first rail and the handle portion couples to the second rail.
